(19) United States
(12) Patent Application Publication
(10) Pub. No.: US 2019/0332237 A1
(43) Pub. Date: Oct. 31, 2019

(54) Method Of Navigating Panels Of Displayed Content

(71) Applicant: LingoZING Holdings LTD, Valletta (MT)

(72) Inventor: Kristian Diakov, Dana Point, CA (US)

(73) Assignee: LingoZING Holdings LTD, Valletta (MT)

(21) Appl. No.: 16/510,119

(22) Filed: Jul. 12, 2019

Related U.S. Application Data
(63) Continuation of application No. PCT/US2018/013569, filed on Jan. 12, 2018.
(60) Provisional application No. 62/446,065, filed on Jan. 13, 2017.

(51) Int. Cl. G06F 3/0485; G06F 3/0482; G06F 3/0488; G06F 3/0484

(52) U.S. Cl. CPC G06F 3/0485; G06F 3/04845; G06F 3/04883; G06F 3/0482

(57) ABSTRACT

A method of navigating panels of displayed content is provided and includes a plurality of image files 20 having graphical data 24, a computing device 10, and a navigation module 50 to navigate and display the image files 20. The computing device 10 includes a memory device 15, a central processing unit 16 that manipulates data stored in the memory device 15 by performing computations ad running the navigation module; and a user interface 12 with a display area 12a to allow a user to access the plurality of image files 20 that provide a sequential juxtaposed panels 19 of displayed graphical data 24 in the display area 12a. The navigation module 50 is run by the central processing unit 16 to permit the user to switch between a display mode of panels 19 and a navigation mode of panels 19 as the user pans across the display area 12a to choose a selected panel 19a.

### CROSS-REFERENCE TO RELATED APPLICATIONS

This application is a continuation of PCT International Application No. PCT/US2018/013569 filed Jan. 12, 2018, which claims priority under 35 U.S.C. § 119 to U.S. Provisional Patent Application No. 62/446,065, filed Jan. 13, 2017.

### FIELD OF THE INVENTION

The invention relates to a method of navigating panels of displayed content on a general user interface and, more particularly, to a method of navigating sequential juxtaposed panels of displayed content on a general user interface.

### BACKGROUND

Traditional publishing onto paper has always permitted a single page's layout to utilize multiple logical content panels. Examples include 1) newspapers and magazines that publish stories with sidebars providing information that does not easily flow into the text of the piece, and graphical insets that provide graphs or photos or other non-textual content that enhances the reader's experience; and 2) comic books, where a page consists of multiple panels that about one another. The screens of the touchscreen computing devices most people use regularly, e.g. smartphones and tablets, are not as large as traditionally published pages, so employing traditional page layout techniques in a much smaller space produces a suboptimal reading experience, with either the logical content panels other than the main text relegated to links at the end of the text, or presented in a way that is proportionally discordant on the screen size of the device it is being viewed, or requiring a user to manually engage in awkward zooming in and out, or sometimes they are omitted entirely. The invention here permits a user to enter into a zoomed in view of a particular logical content panel and view its contents, and to change the focus of the zoomed in content to adjacent logical content panels by using touchscreen swipe gestures.

U.S. Pat. No. 8,301,999 is directed to a method and system for automatically navigating a digitalized comic book or other sequence of illustrative scenes within a digital production. The method and system provides for two viewing modes: a first viewing mode in which a page is visible in its entirety on a display screen without visually distinguishing one panel from other panels, and a second viewing mode in which one of a sequence of illustrative scenes is visually enhanced so as one displayed illustrative scene is more readily perceived than an adjacent illustrative scene and the dimensions of each displayed illustrative scene are independent of the dimensions of each of the other panels within the digital production. A user of the method or system can request either the first or second viewing mode. The method and system can be locally or remotely controlled and stored. Accordingly, this is a very broad method in navigating scenes of a storyline-framed sequence.

More particularly, the '999 patent focuses on creating a display experience and, more particularly, displaying each of the sequence of illustrative scenes with visual enhancement that makes each displayed illustrative scene more readily perceived than an adjacent illustrative scene within the specified order, wherein dimensions of each displayed illustrative scene are independent of dimensions of each of the panels within the digital production. As a result, the visual enhancement of the enhanced frame and its dimensions are independent of the dimensions: of any of the panels in the original sequence, meaning that they do not correspond. For example, as shown in FIGS. 10A and 12B, the enhanced panel 1004 is truncated, while the original panel 1204 is elongated, which creates a unique visual effect. This is a disproportional display of an original frame.

Furthermore, the '999 patent focuses a user on specific actions such as selecting a button, actuating the navigational control buttons by manipulating a mouse or other input mechanism . . . in order to click on a button, positioning a cursor or other location indicator over the panel, or by clicking on a specific panel. With continuing development of touchscreen devices, the use of swiping to navigate the content is required.

Accordingly, it is desirable to provide a method and related tools to improve the ability of a user to navigate through the digitized content by switching screen views of sequential cells using simple commands, such as swiping.

### SUMMARY

As a result a method of navigating sequential juxtaposed panels of displayed content on a general user interface is provided. The system generally includes a plurality of image files having graphical data, a computing device, and a navigation module to navigate and display the image files. The computing device includes a memory device, a central processing unit that manipulates data stored in the memory device by performing computations and running the navigation module; and a user interface with a display area to allow a user to access the plurality of image files that provide a sequential juxtaposed panels of displayed graphical data in the display area. The navigation module is run by the central processing unit to permit the user to switch between a display mode of panels and a navigation mode of panels as the user pans across the display area to choose a selected panel.

### BRIEF DESCRIPTION OF THE DRAWINGS

The invention will now be described by way of example with reference to the accompanying Figures of which:

FIG. 1 is a flow diagram of hardware and network infrastructure for a display system according to the invention;

FIG. 2 is a schematic diagram of a connection device of the display system according to the invention;

FIG. 3 is a graphical representation of a display module of the display system according to the invention showing a general user interface having a plurality of sequential juxtaposed panels;

FIG. 4 is a graphical representation a display system using a navigation module according to the invention to navigate between the sequential juxtaposed panels of a display area;

FIG. 5 is a graphical representation a display system using a navigation module according to the invention, showing a selected panel of sequential juxtaposed panels of a display area;

FIG. 6 is a graphical representation the display system of FIG. 5, showing a first step of a linear gesture to navigate between the sequential juxtaposed panels of the display area;

FIG. 7 is a graphical representation the display system of FIG. 6, showing a subsequent step of the linear gesture to navigate between the sequential juxtaposed panels of the display area;

FIG. 8 is a graphical representation the display system of FIG. 7, showing another subsequent step of the linear gesture to navigate between the sequential juxtaposed panels of the display area;

FIG. 9 is a graphical representation the display system of FIG. 8, showing another subsequent step of the linear gesture to navigate between the sequential juxtaposed panels of the display area;

FIG. 10 is a graphical representation the display system of FIG. 9, displaying a subsequent panel selected through the linear gesture to navigate between the sequential juxtaposed panels of the display area;

FIG. 11 is a graphical representation a display system using a navigation module according to the invention, showing a selected panel of sequential juxtaposed panels of a display area;

FIG. 12 is a graphical representation the display system of FIG. 11, showing a first step of a linear gesture to navigate between the sequential juxtaposed panels of the display area;

FIG. 13 is a graphical representation the display system of FIG. 12, showing a subsequent step of the linear gesture to navigate between the sequential juxtaposed panels of the display area;

FIG. 14 is a graphical representation the display system of FIG. 13, showing another subsequent step of the linear gesture to navigate between the sequential juxtaposed panels of the display area;

FIG. 15 is a graphical representation the display system of FIG. 14, displaying a subsequent panel selected through the linear gesture to navigate between the sequential juxtaposed panels of the display area;

FIG. 16 is a graphical representation a display system using a navigation module according to the invention, showing a selected panel of sequential juxtaposed panels of a display area;

FIG. 17 is a graphical representation the display system of FIG. 16, showing a first step of a linear gesture to navigate between the sequential juxtaposed panels of the display area;

FIG. 18 is a graphical representation the display system of FIG. 17, showing a subsequent step of the linear gesture to navigate between the sequential juxtaposed panels of the display area;

FIG. 19 is a graphical representation the display system of FIG. 18, showing another subsequent step of the linear gesture to navigate between the sequential juxtaposed panels of the display area;

FIG. 20 is a graphical representation the display system of FIG. 19, showing another subsequent step of the linear gesture to navigate between the sequential juxtaposed panels of the display area;

FIG. 21 is a graphical representation the display system of FIG. 20, displaying a subsequent panel selected through the linear gesture to navigate between the sequential juxtaposed panels of the display area;

FIG. 22 is a graphical representation a display system using a navigation module according to the invention, showing a selected panel of sequential juxtaposed panels of a display area;

FIG. 23 is a graphical representation the display system of FIG. 22, showing a first step of a linear gesture to navigate between the sequential juxtaposed panels of the display area;

FIG. 24 is a graphical representation the display system of FIG. 23, showing a subsequent step of the linear gesture to navigate between the sequential juxtaposed panels of the display area;

FIG. 25 is a graphical representation the display system of FIG. 24, showing another subsequent step of the linear gesture to navigate between the sequential juxtaposed panels of the display area;

FIG. 26 is a graphical representation the display system of FIG. 25, showing another subsequent step of the linear gesture to navigate between the sequential juxtaposed panels of the display area;

FIG. 27 is a graphical representation the display system of FIG. 26, showing another subsequent step of the linear gesture to navigate between the sequential juxtaposed panels of the display area; and

FIG. 28 is a graphical representation the display system of FIG. 27, displaying a subsequent panel selected through the linear gesture to navigate between the sequential juxtaposed panels of the display area;

### DETAILED DESCRIPTION OF THE EMBODIMENT(S)

The invention will now be described in greater detail with reference to an embodiment including the attached figures.

A display system 1 according to the invention will be described through exemplary embodiments as shown in the Figures. Generally, the display system 1 employs software and hardware to navigate sequential juxtaposed panels of displayed content through a general user interface.

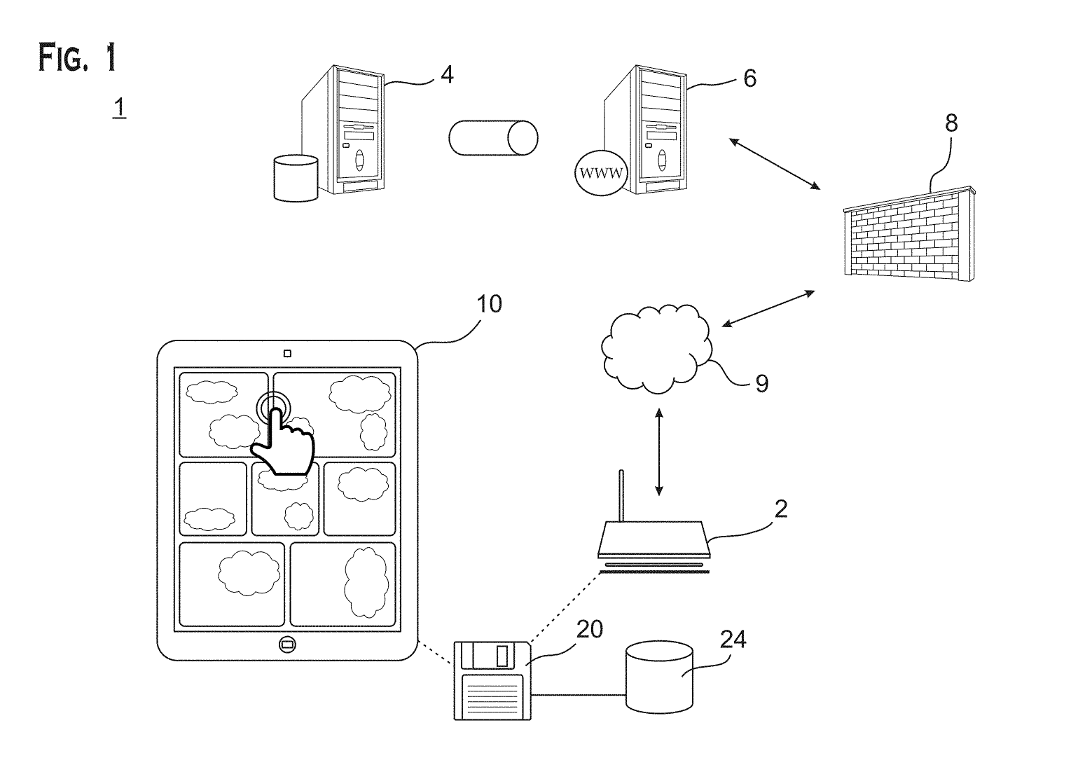

Referring first to FIG. 1, hardware infrastructure for an embodiment of the display system 1 will be described. In an exemplary embodiment, the display system 1 is built on a network router 2 (for instance, a wireless router) and connected to a database server 4, while also utilizing known hardware components, including a web server 6, a firewall 8, a network 9, and the computing device 10.

The display system 1 allows a user to access to a plurality of image files 20 that includes graphical data 24, such as information and images, through the computing device 10 and a network traffic information on the database server 4 (i.e. SQLServer or WindowsServer2012 or newer) that connects to a web server 6. The web server 6 functions as a way for network router 2 to communicate to the database server 4 through an application-programming interface (API) between the computing device 10 and the database server 4. A firewall 8 is integrated for security purposes such as, but is not limited to, blocking unauthorized access to the web server 6 and permitting unauthorized communication thereto. The display system 1 is designed to run through the computing device 10 through the image files 20 that are downloaded over personal area networks (PANs), local area networks (LANs), campus area networks (CANs), wide area networks (WANs), metropolitan area networks (MANs) and any new networking system developed in the future. These networks are represented with the network 9. One skilled in the art should appreciate that the display system 1 can be maintained solely through the computing device 10, as the image files 20 can be pre-loaded to the computing device 10. In the shown embodiment, the user connects to the network router 2 using the computing device 10 through the network 9.

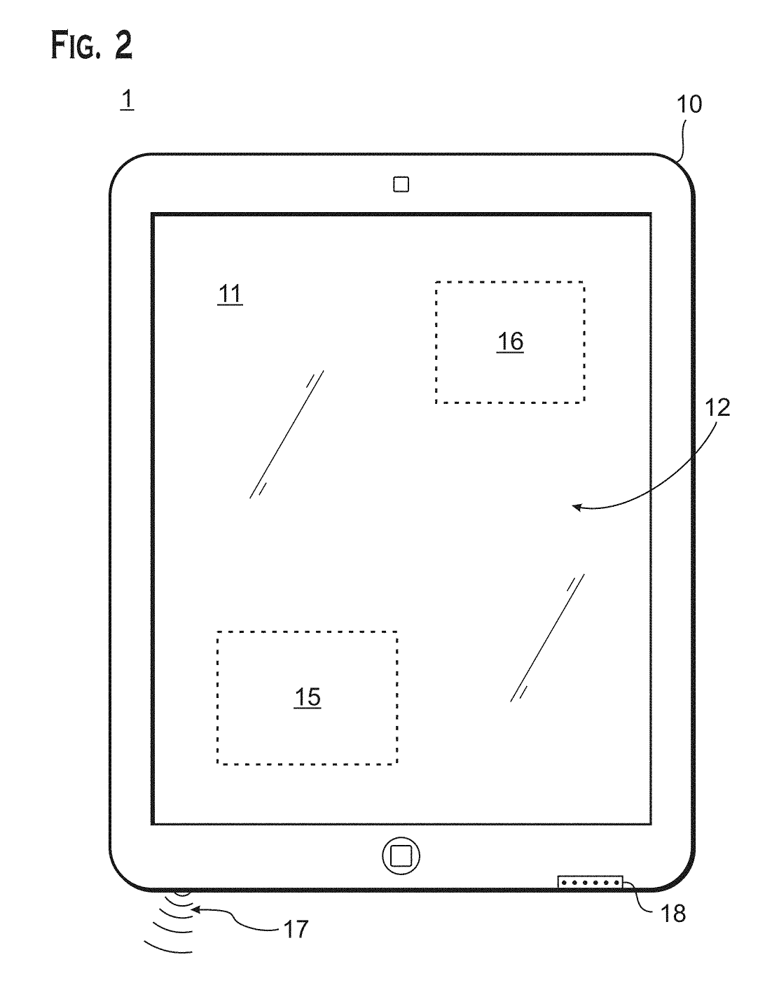

With reference to FIG. 2, the computing device 10 will be described. The computing device 10 generally includes a general user interface 12 with a display area 12a, a memory device 15, and a processor 16. In the shown embodiment, the computing device 10 is a tablet computer with a touchscreen display 11. The computing device 10 includes sensors, including an audio output device 17 and an audio input device 18. The audio output device 17 may be a speaker or an audio jack, while the audio input device 18 may be an internal microphone. The touchscreen display 11 uses finger or stylus gestures to navigate the general user interface 12. However, one skilled in the art should appreciate that other implements could be used; including a computer mouse, a keyboard, or joystick. In fact, one skilled in the art should appreciate that the computing device 10 is a physical computer and could be, but not limited to, a desktop computer, a laptop computer, or a cell phone. The memory device 15 is a storage device having computer components and recording media used to retain digital data. The processor 16 is a central processing unit (CPU) that manipulates data stored in the memory device 15 by performing computations.

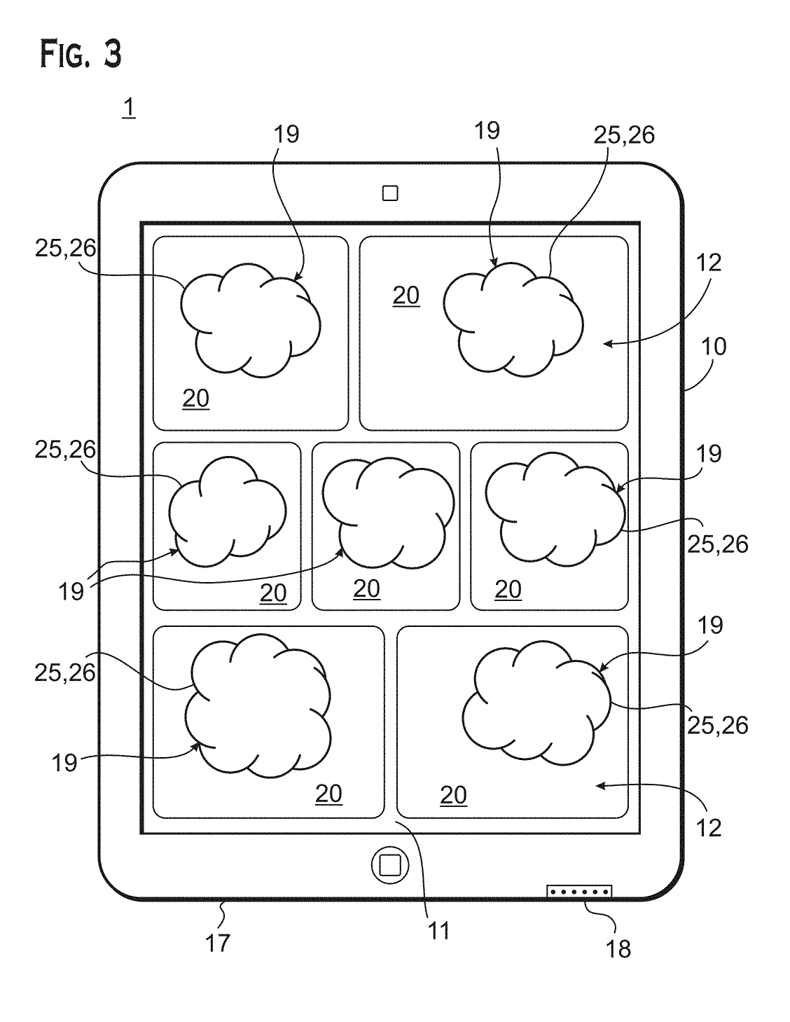

With reference to FIG. 3, the image file 20 will be described by way of illustration of the general user interface 12 for the computing device 10.

The image file 20 includes a sequence of instructions, which is written to perform a specified tasks to display, and generally includes a display module and an auditory module. The image file 20 further includes graphical data 24, including graphical elements 25, lexical elements 26, and, in some cases, auditory elements (not shown). In particular, the display module displays graphical elements 25 and lexical elements 26 through the general user interface 12. The auditory module also performs auditory function by broadcasting auditory elements 27 corresponding to the graphical elements 25 and the lexical elements 26.

As shown in FIG. 3, the display system 1 displays one or more pages graphical data 24. The graphical data 24 is stored in relational databases, which include data elements listed in related tables that match up to links that are identified as panels 19 in FIG. 3. As shown, a single page will include one or more panels 19. These panels 19 correspond to coordinates along the general user interface 12.

As shown in FIG. 3, an example of how the graphical data 24 associated with each panel 19 could be stored in a database, using the index key to identify which panel's data is utilized by the auditory module, and the various other elements associated with the index key can be called up to either fill the text panel with text in the desired language, or cause the device to play an audio recording of the text being spoken.

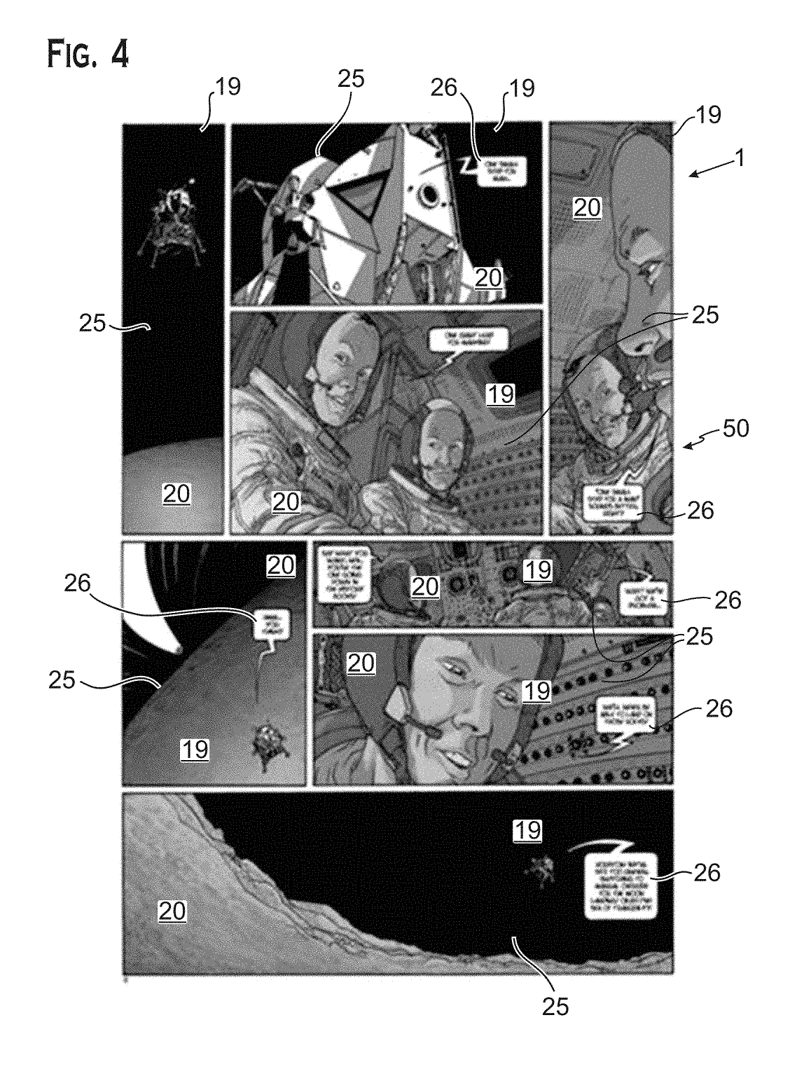

Now with reference to FIGS. 4, a navigation module 50 for the display system 1 will be described.

In general, the navigation module 50 provides a system and method for users to navigate sequential juxtaposed panels 19 of displayed graphical data 24 through the display system 1. More particularly, a user can switch between a display mode of panels 19 and a navigation mode of panels 19 through the display system 1. As shown in FIG. 3, the display mode includes 100% of displayable content for each page for the display system 1. For instance, as shown in FIG. 4, display mode displays a complete page of panels 19. More particularly, FIG. 4 shows eight panels 19 that fill 100% of available display area 12a of the general user interface 12.

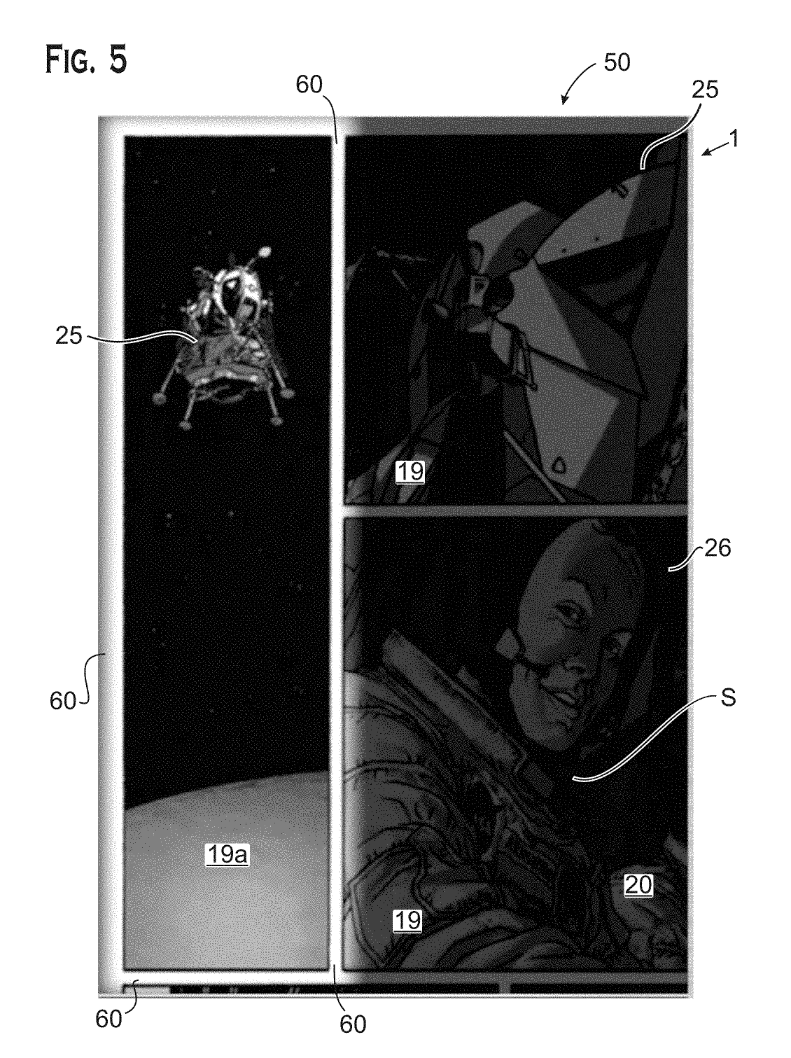

In contrast, as shown in FIG. 5, a user, in a navigation mode, chooses a selected panel 19a through the general user interface 12. The navigation module 50 pans across the complete page and toward the selected panel 19a. While panning, the navigation module 50 then zooms in and displays a zoomed image of the selected panel 19. In the shown embodiment, the selected panel 19a may occupy ˜85-90% of the available of available display area 12a. In addition, sequential juxtaposed panels 19 are shown surrounding the selected display 19a. In the embodiment shown, the sequential juxtaposed panels 19 take up the remaining ˜10-15% of the available display area 12a.

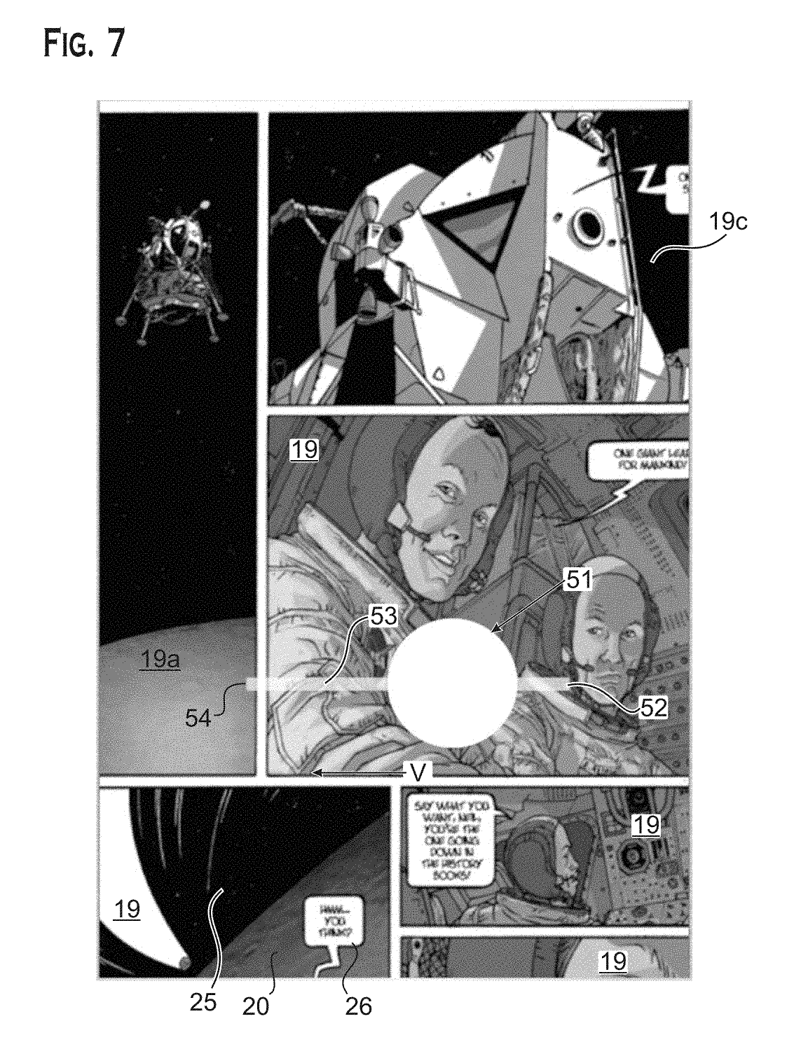

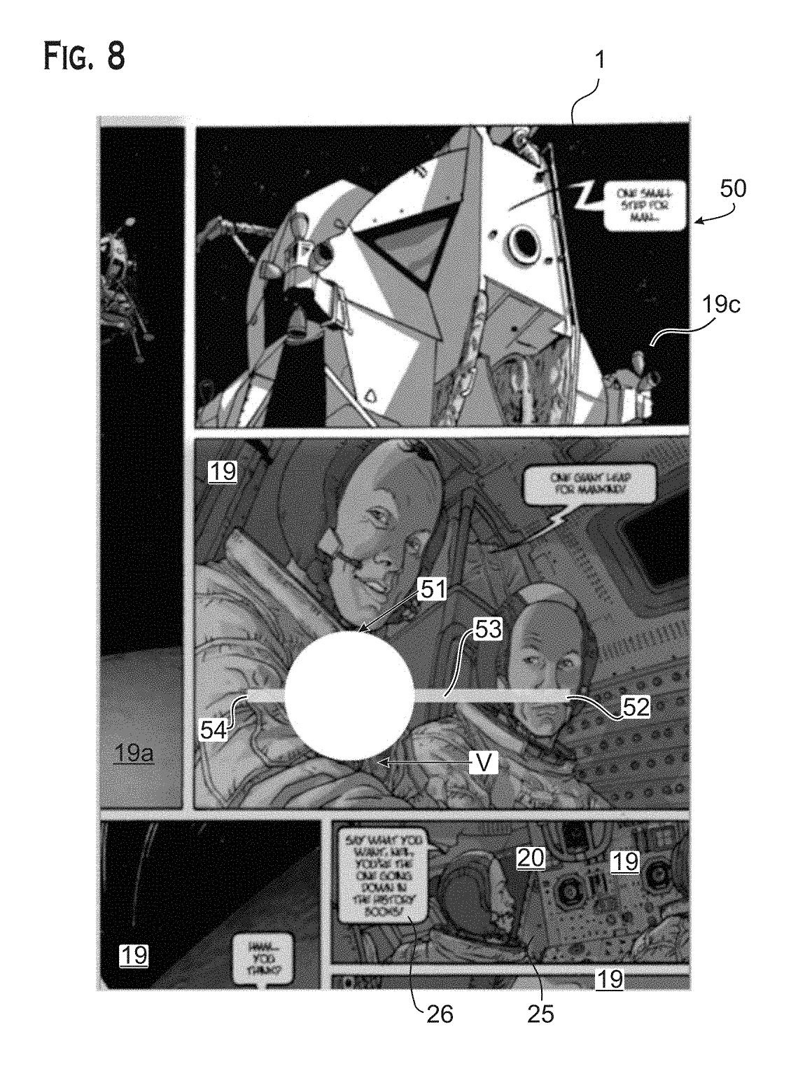

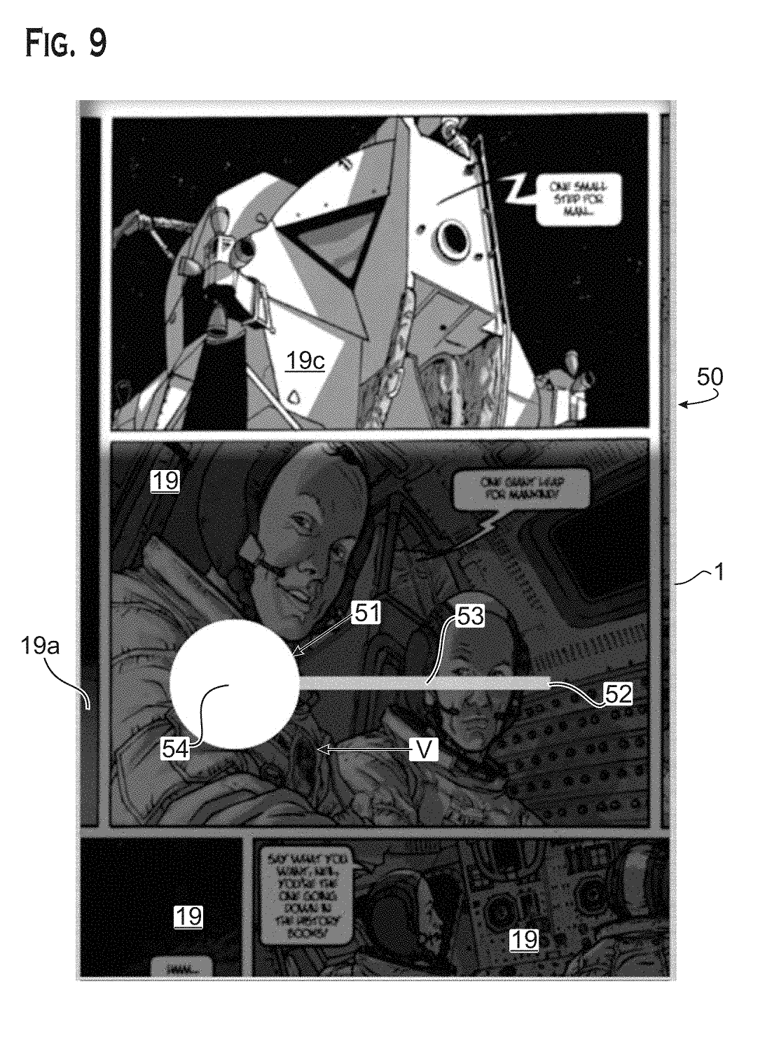

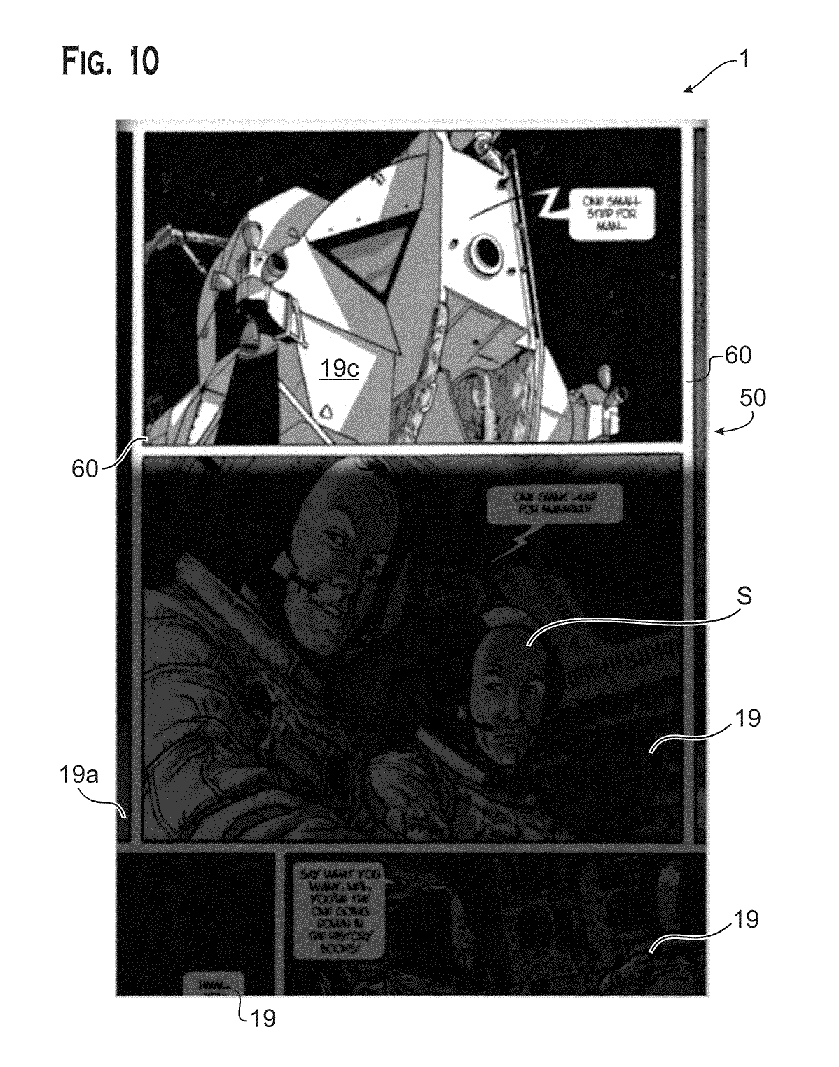

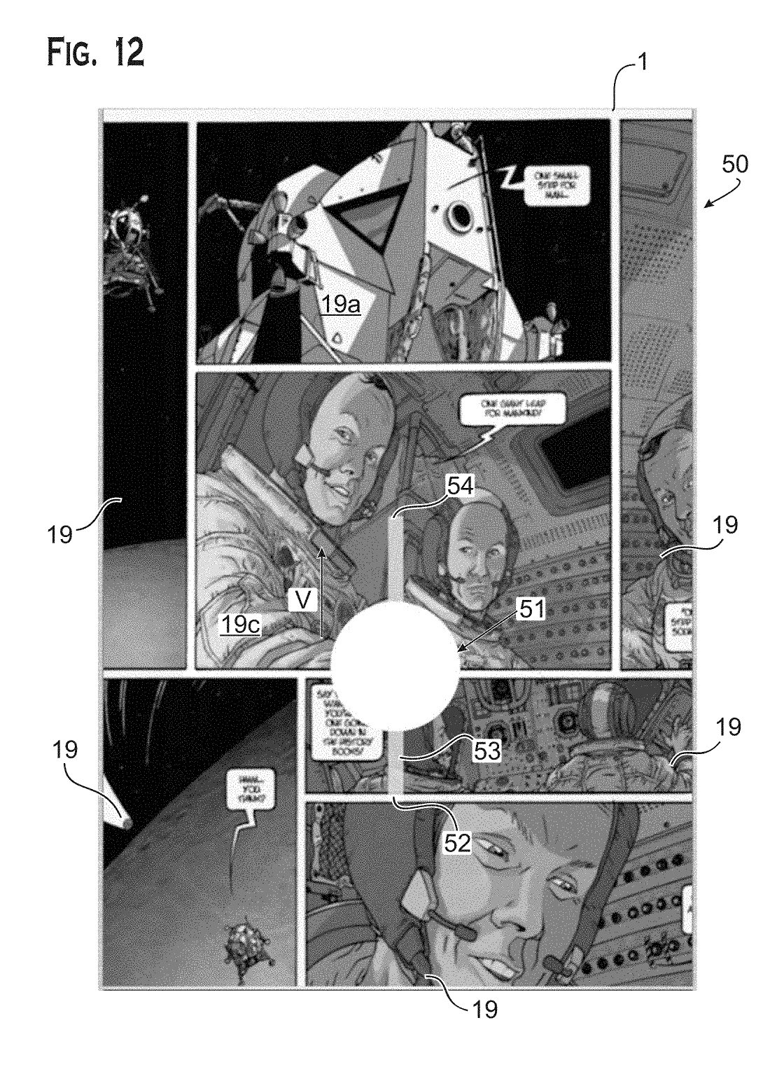

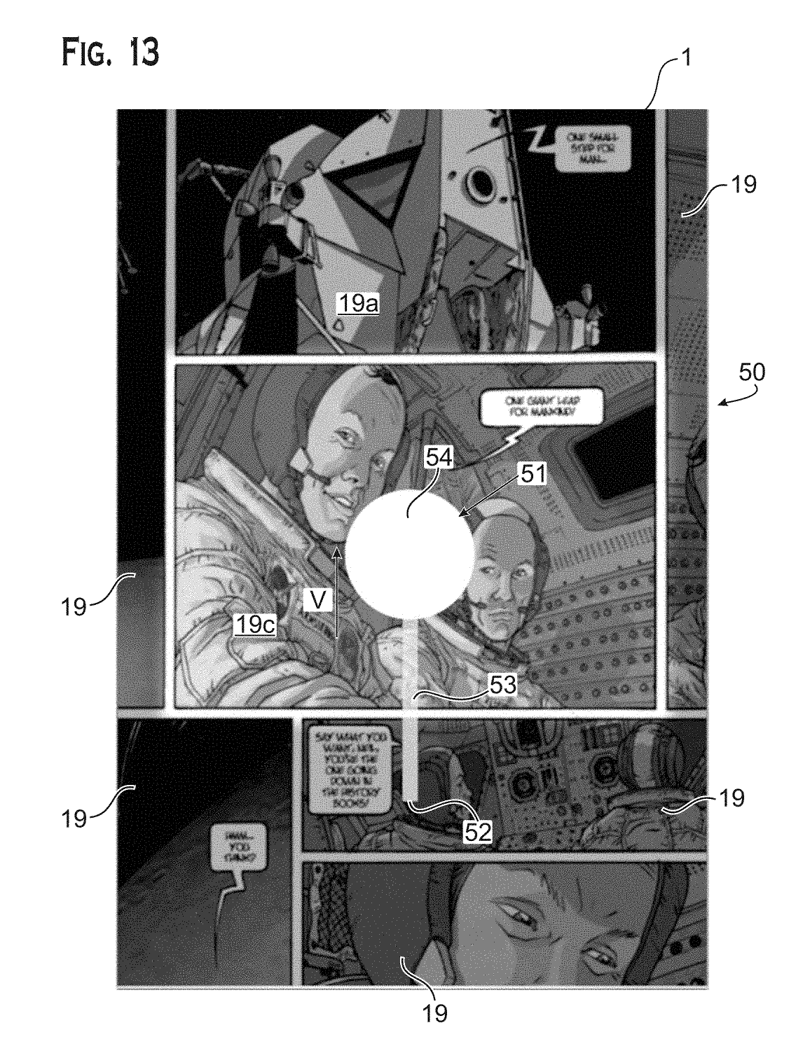

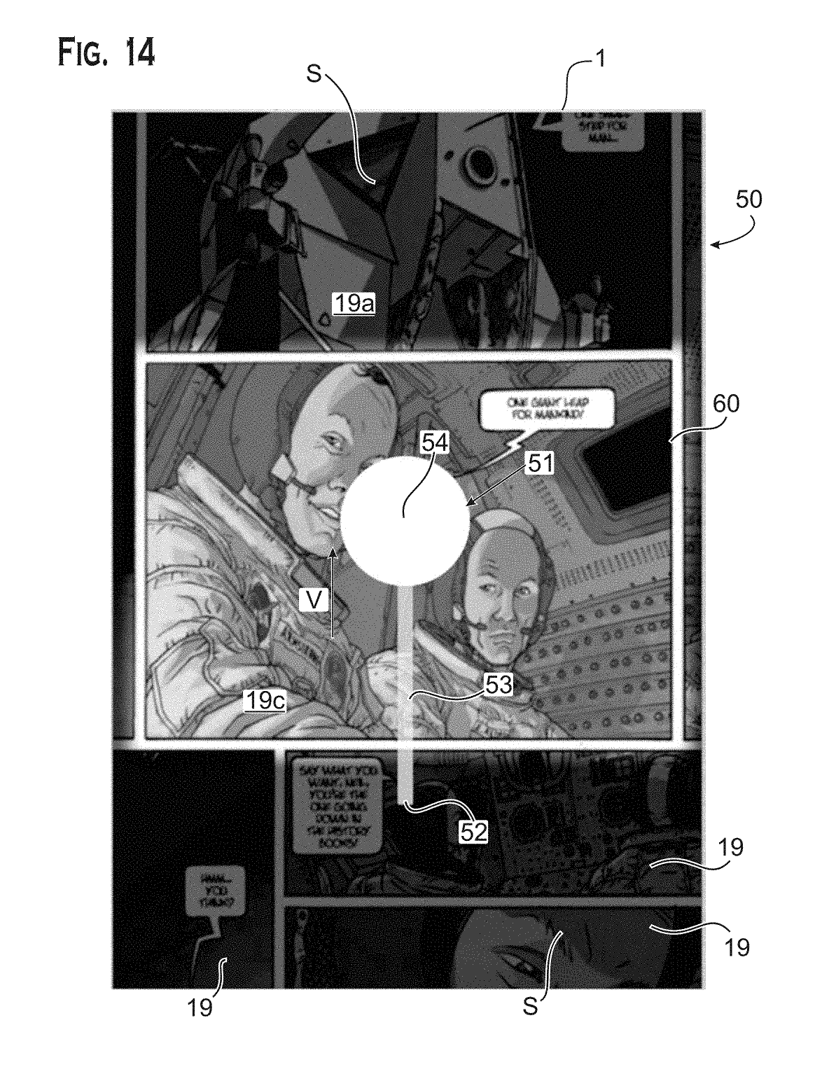

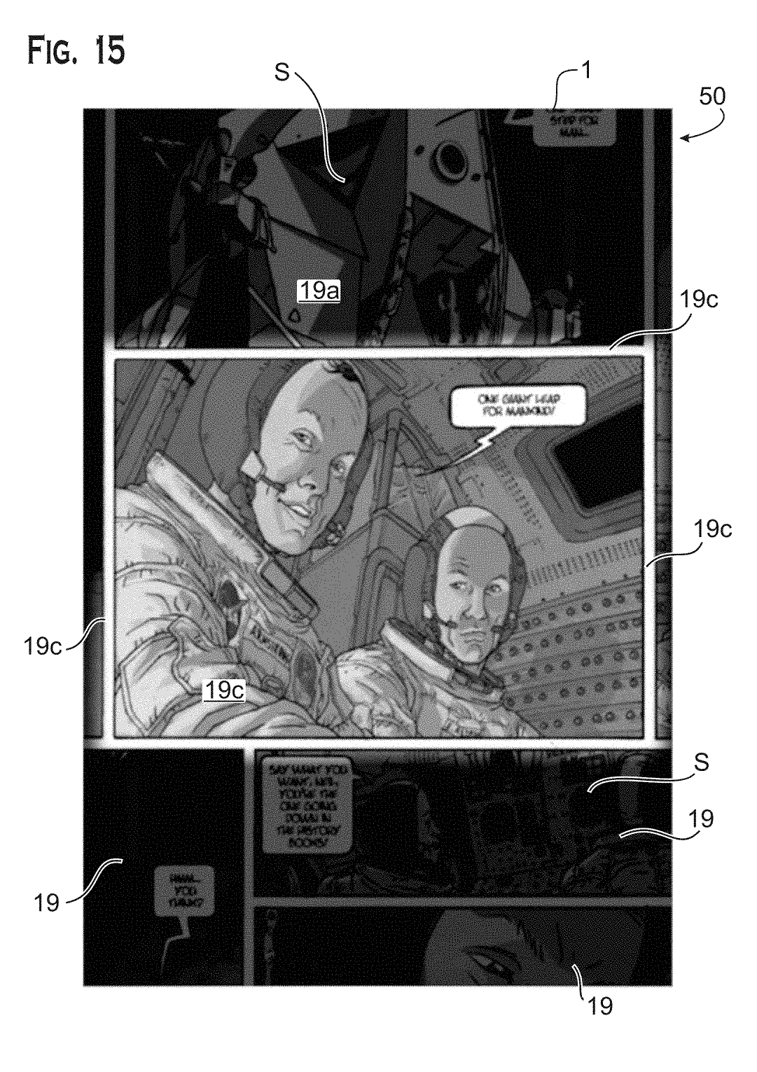

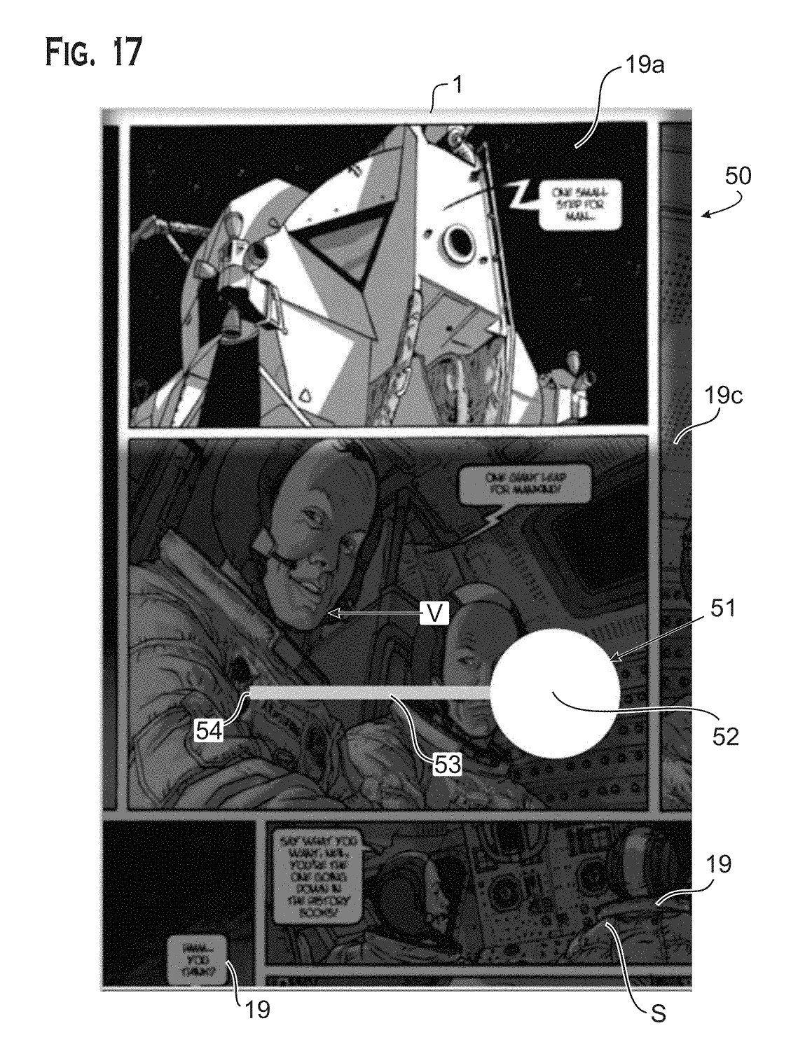

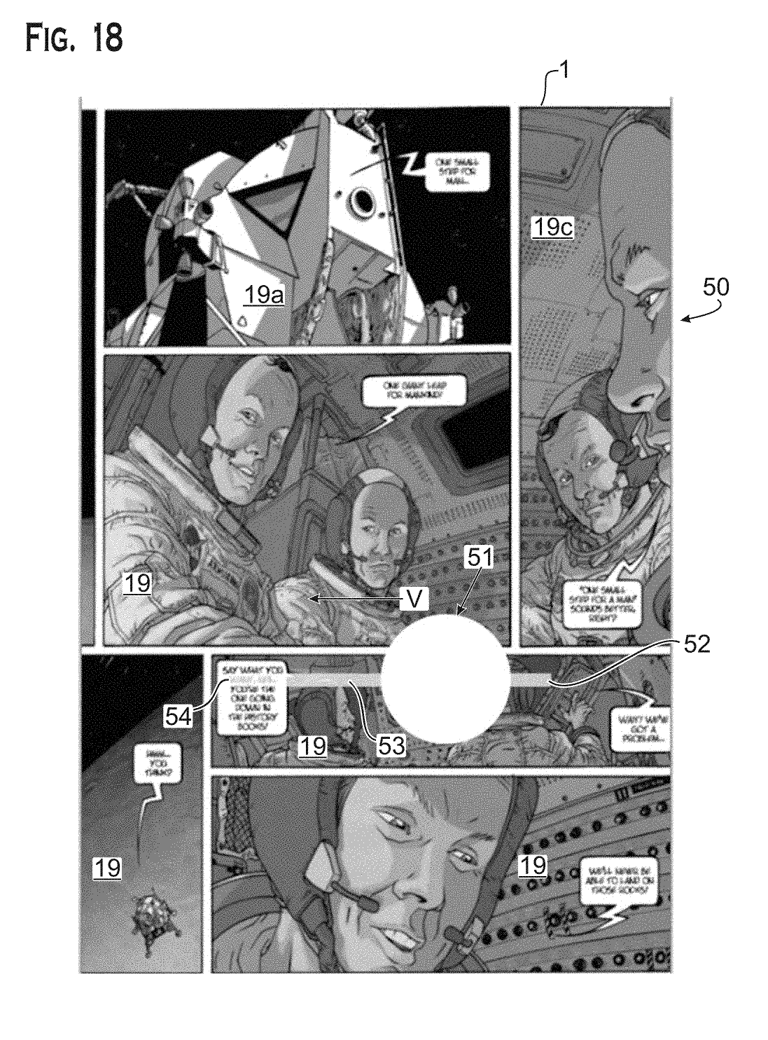

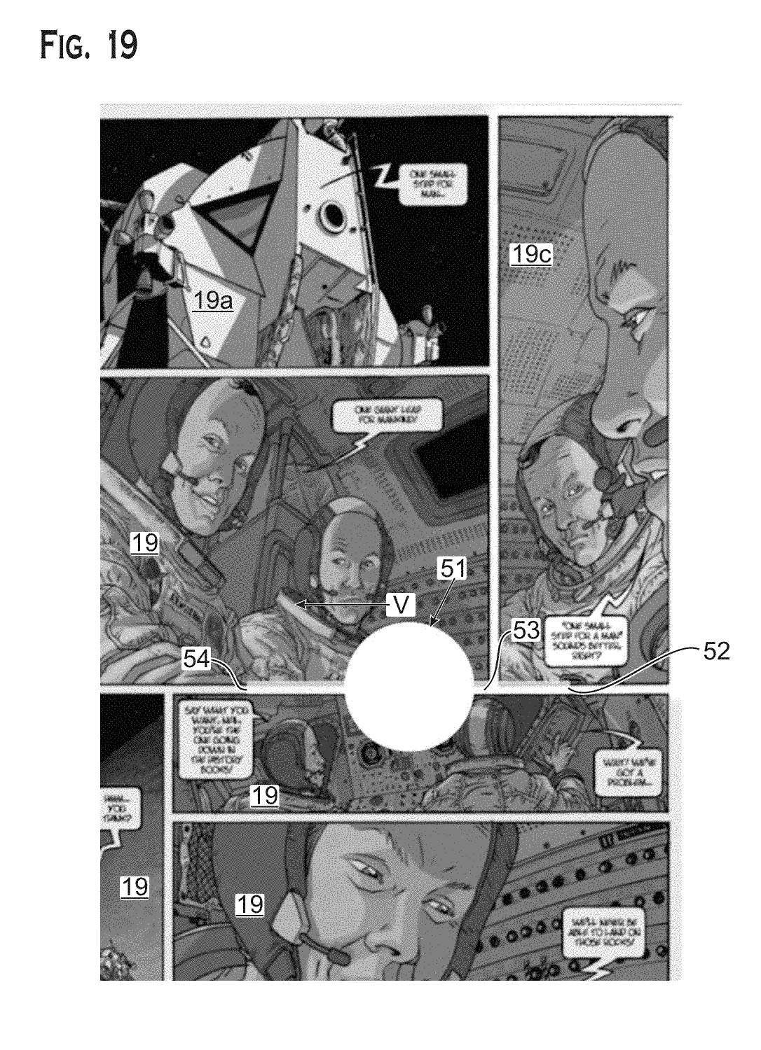

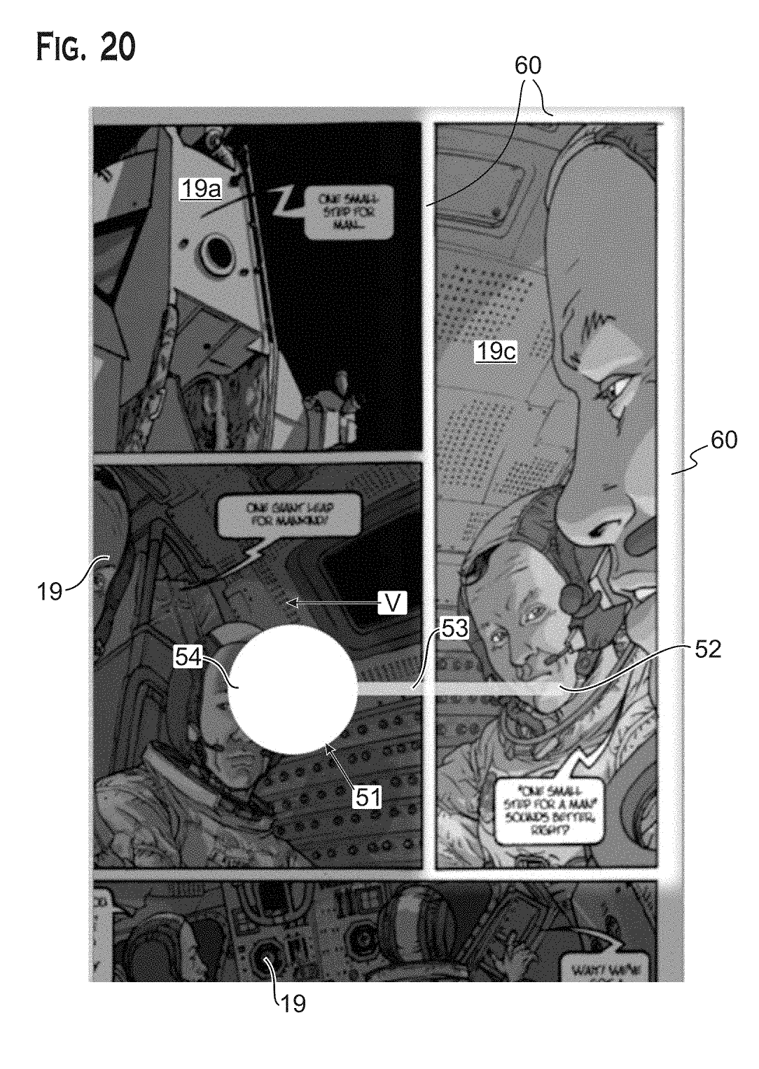

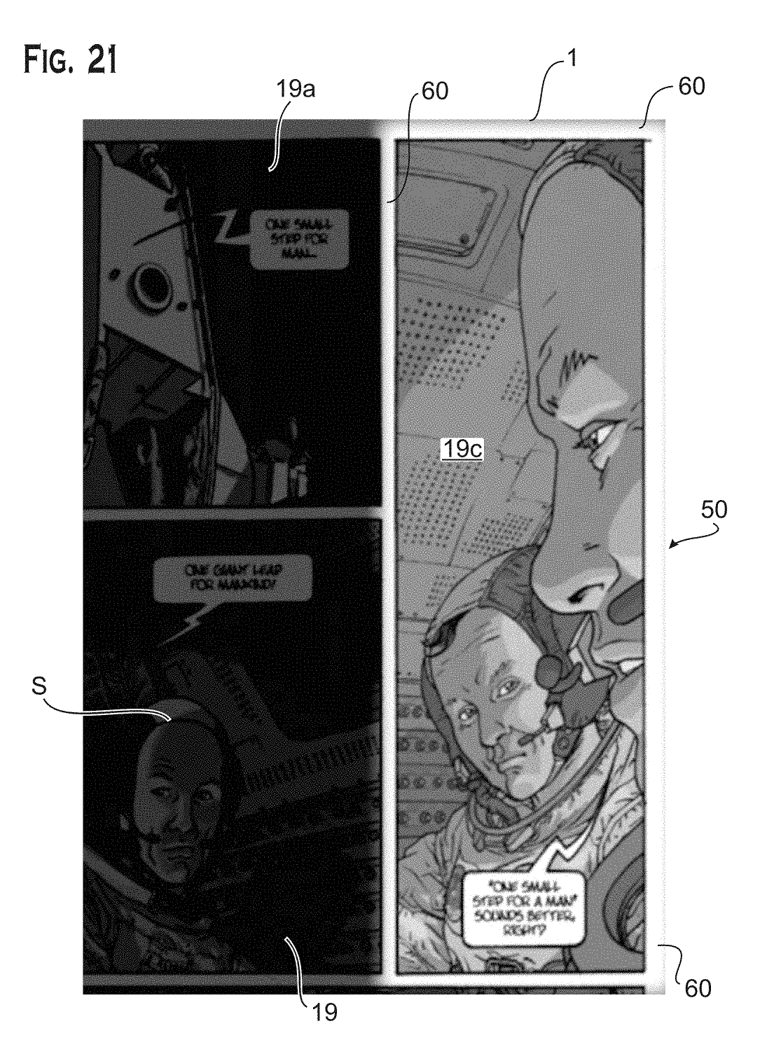

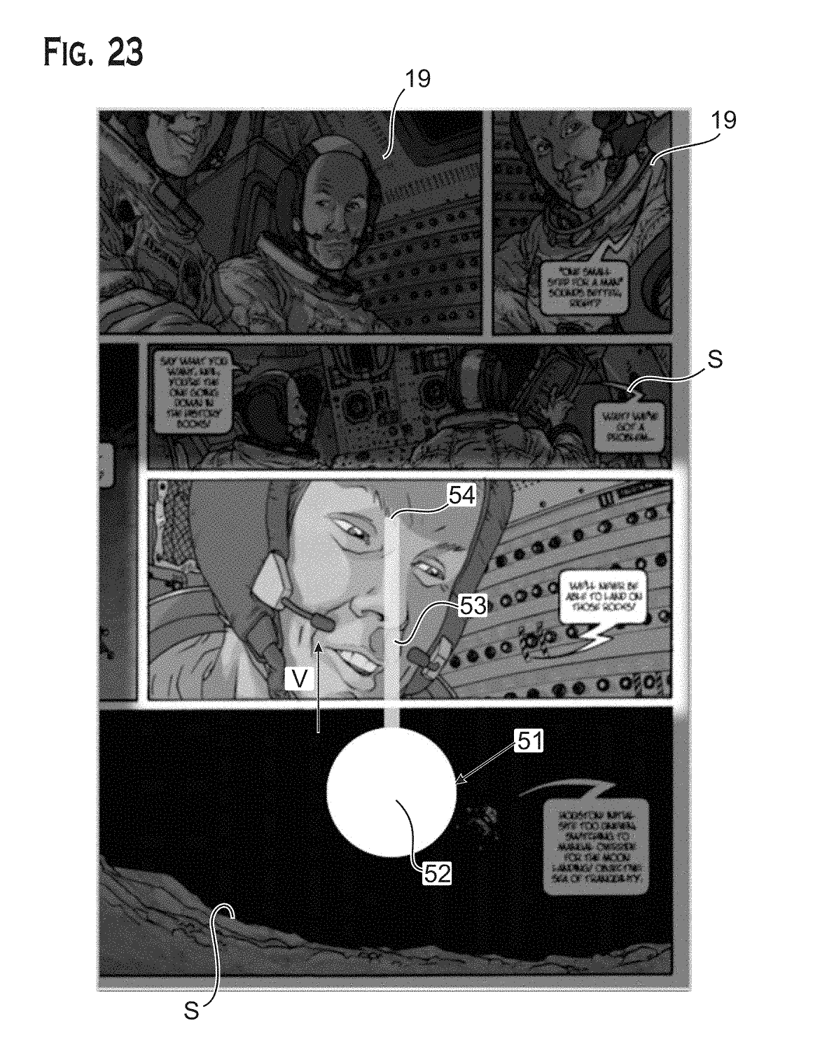

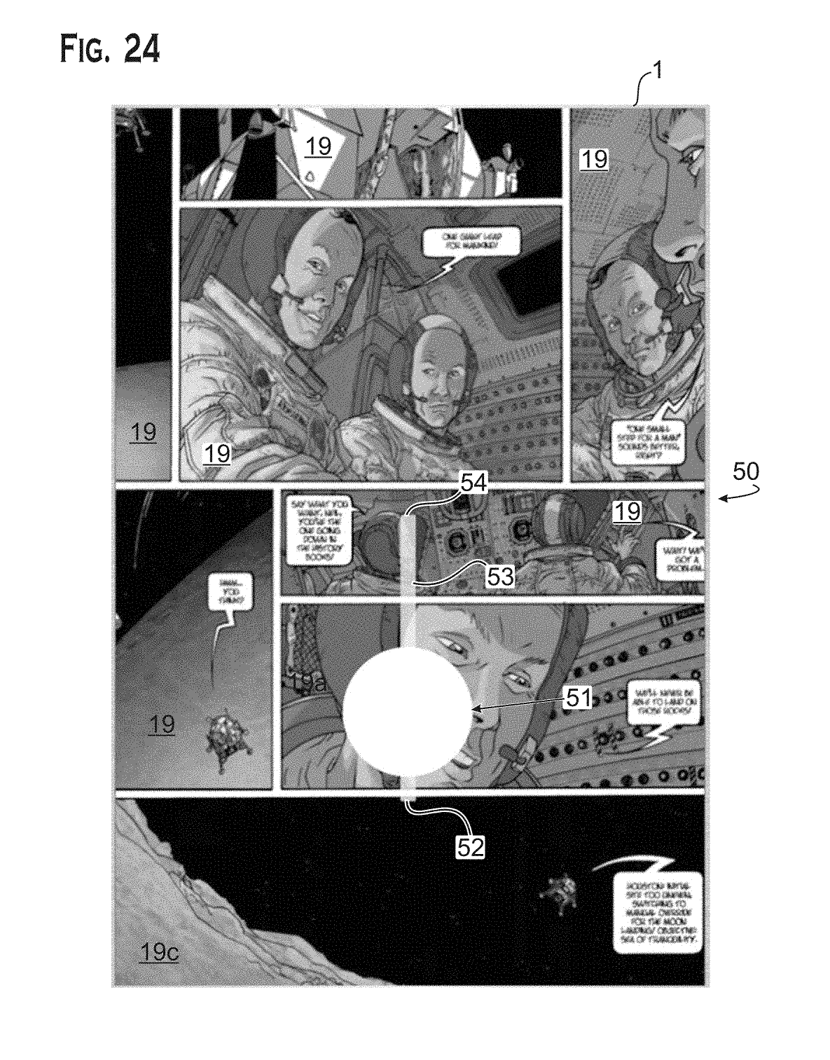

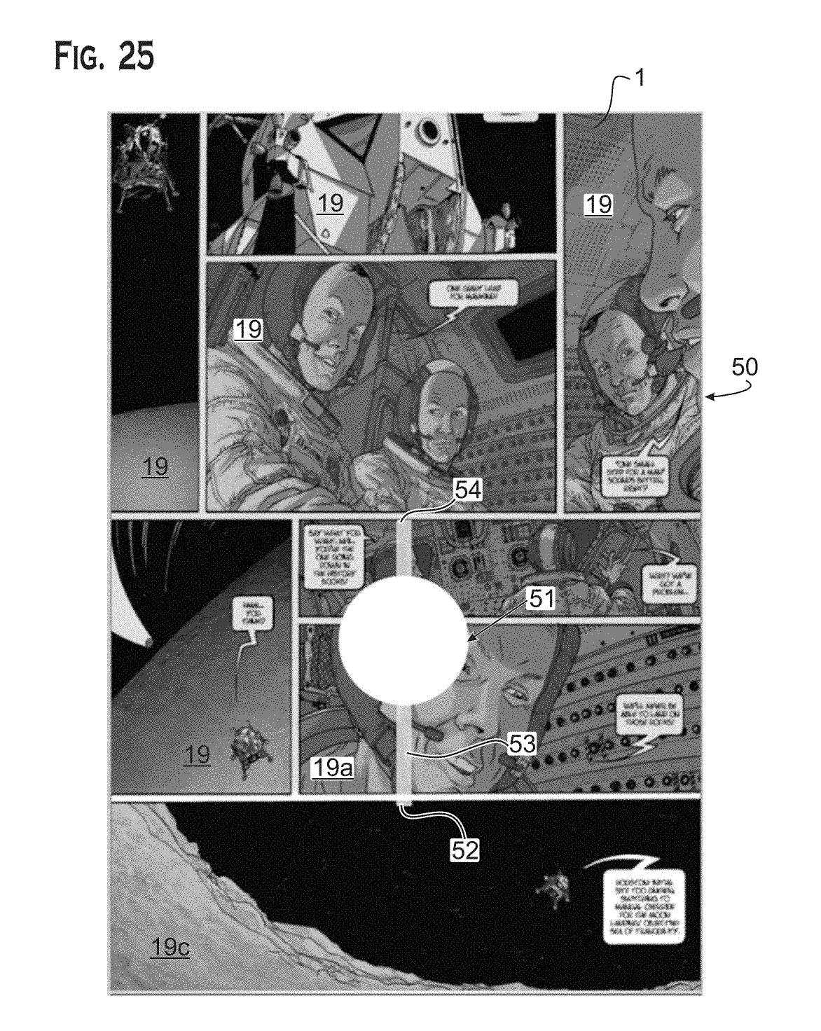

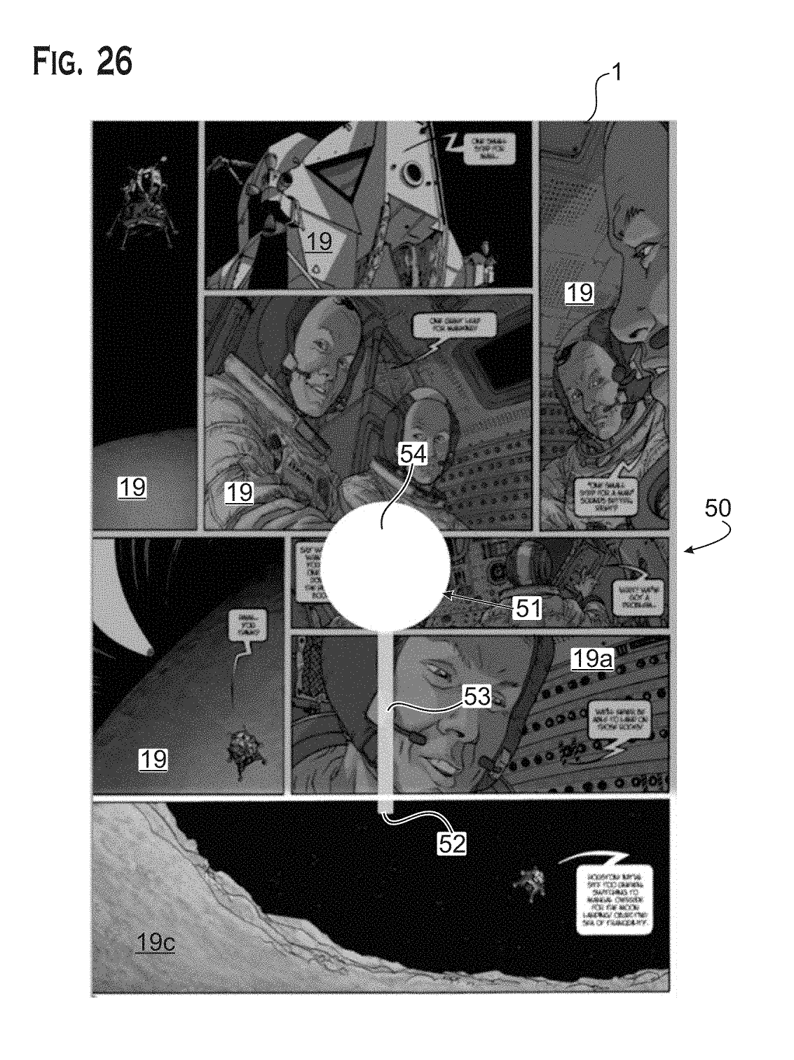

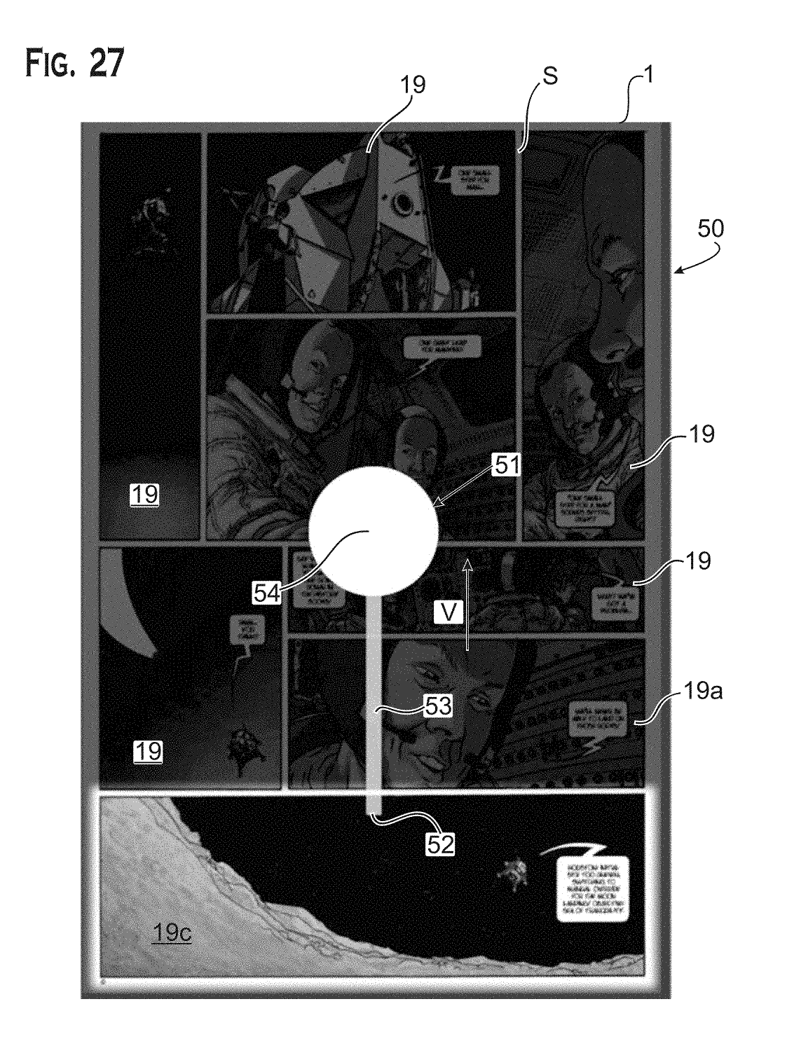

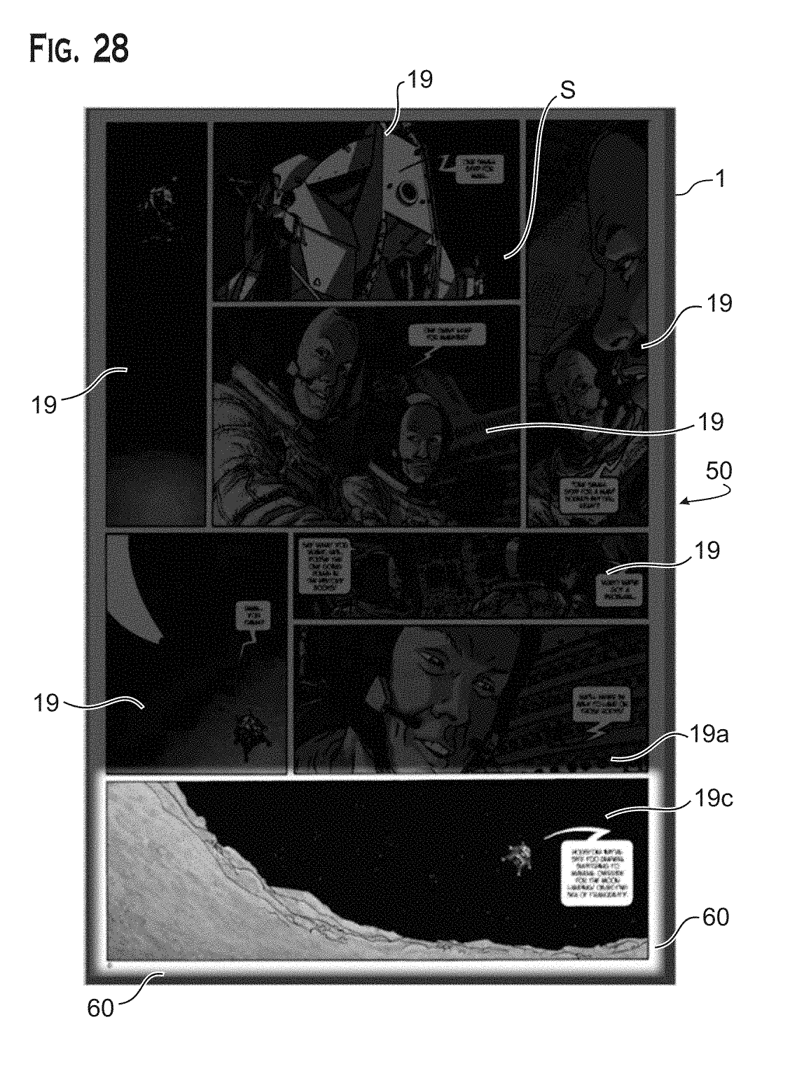

As shown in FIGS. 4-28, the navigation module 50 uses the computing device 10 with a touch screen 13 having an overlay on top of the touchscreen computing devices' operating systems' standard input and output processing techniques. The overlay on top of the input and output system identify specific areas on the screen as selectable elements, i.e. graphical elements 25, lexical elements 26, and is designed to detect and process a gesture which is recognized as an arc that would contain the elements the user desires to select.

Starting with FIGS. 4 through 10, the juxtaposed panels 19 are positioned in sequential order, for instance, in a story line. Firstly, a user selects the selected panel 19a by touching the touch screen 13 to correspond with a panel 19 within the general user interface 12. This initiates the navigation module 50. The navigation initiation location 52 of the initial touch is stored in memory device 15 and corresponds to a specific coordinate of a coordinate system of the general user interface 12. The navigation module 50 zooms into the selected panel 19a and places a soft edge effect 60 about the selected panel 19a. The navigation module 50 concurrently provides shading S on top of any sequential juxtaposed panels 19 surrounding the selected panel 19a. In the shown embodiment of FIG. 5, the navigation module 50 provides a ˜20 px of soft transition from 100% transparent at the edge of the scene to 80% opaque.

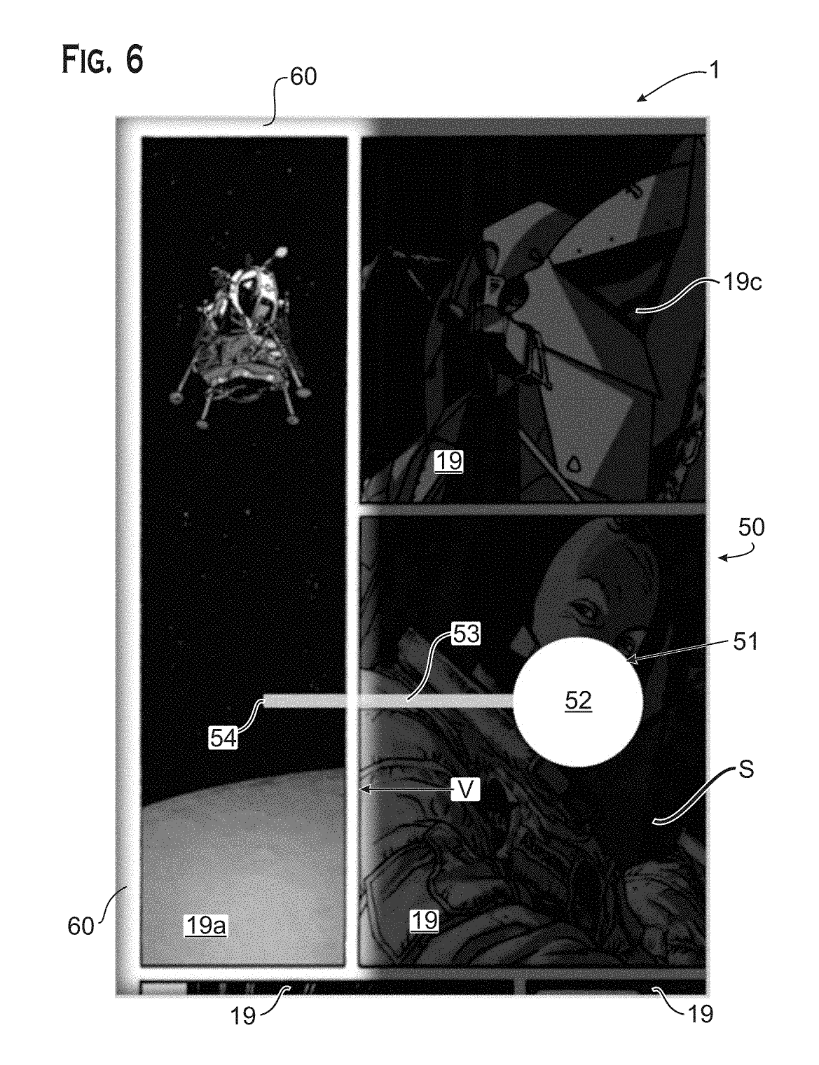

As shown in FIG. 6, the user can continue the story line of the sequential juxtaposed panels 19 by again pressing the general user interface 12 and providing a navigation initiation location 52. Then, the user can select the subsequent panel 19c by performing a swipe gesture, i.e. up, down, left, or right direction, with respect to the position of the selected panel 19a and the surrounding sequential juxtaposed panels 19. This is performed by a complete swipe gesture in one continuous linear motion, by pressing the finger of the computing device 10 (e.g. touching the screen and then moving in a direction using a continuous motion), the navigation initiation location 52 is generated and stored by the navigation module 50. The user performs a linear gesture through a continuous swipe 51 of constant or variable linear dimensions in the embodiment shown. However, one skilled in the art should appreciate that the navigation module 50 could require other geometrical paths, such as arcs. In particular, in the embodiment shown, when the navigation module 50 is triggered, a display sequence is triggered and is exemplary shown in FIGS. 5-10 in the embodiment shown. For instance, the display sequence is a sequential display of image files 20 that represent a combined zoom out/re-center/zoom-in motion of the sequential juxtaposed panels 19. Further, a sequence of shading S is also performed. For instance, when the user zooms out of the selected panel 19a, the shading S of the surrounding sequential juxtaposed panels 19 goes from 100% to 100%->0%->100% and then back 100% when the subsequent panel 19c is zoomed in on.

According to the invention, the navigation module 50 evaluates the path of the continuous swipe 51 by determining a distance (L) between the navigation initiation location 52 and a navigation end location 54 of the linear path of the continuous swipe 51. The navigation end location 54 is determined once the swipe gesture has stopped. Once the navigation module 50 concludes a linear path has started, the navigation module 50 starts calculating a direction vector (V) of the continuous swipe 51 through the selected coordinates of the navigation initiation location 52 and an intermediate path 53, which are coordinates between the initiation location 52 and present position of the continuous swipe 51.

As shown in FIGS. 5 through 10, the user provides a navigation initiation location 52 that is consistent with a position of the subsequent panel 19c with respect to the selected panel 19. The user then slides across the general user interface 12 to a navigation end location 54 that is consistent with a position and direction of the selected panel 19a. In the shown embodiment, this is lateral motion and the navigation module 50 identifies this is in the form of a direction vector V, or lateral swipe in the embodiment shown. The navigation module 50 then determines the subsequent panel 19c and performs a display sequence as described above. At any time, the sequence can be controlled and moved back and forth by moving along the continuous swipe 51 before the finger is lifted from the touchscreen 13. For instance, the user can zoom out of the selected panel 19a by 30-40%, re-center on the subsequent panel 19c, and then zoom back to the selected panel 19a. As a result, instead of treating each panel 19 as separate slides in a linear sequence, the user rather zooms in and out on the page while navigating the panels of the general user interface 12.

The calculation logic of the navigation module 50 can be split into two general steps: (1) calculating the navigation initiation location 52 and the navigation end location 54, and (2) calculating the intermediate path 53 there between.

When calculating the navigation initiation location 52, a zoom factor must be accounted for. For instance, if the selected panel 19a width is less than 95% of the display area 12a width, the navigation module 50 will apply a scale such that the width of the selected panel 19a is 95% of the display area 12a width. If a height of the selected panel 19a is greater than 95% of the display area 12a height, then the navigation module 50 decreases the scale factor so that the height of the selected panel 19a is 95% of the display area 12a height. Furthermore, the navigation module 50 positioned the selected panel 19a in the center of the display area 12a. If any edge of the selected panel 19a is outside the display area 12a, the navigation module 50 adjusts position to align the selected panel 19a edge with the corresponding display area 12a edge.

The navigation module 50 also the user to control the display sequence, as discussed above. In the shown embodiment, the user can use up to 50% of the display area 12a width/height as motion control gesture size, i.e. if the swipe covers 50% of the display area 12a, that navigation module 50 identifies the navigation end location 54 to determine the direction vector V, much like lifting the finger off the touchscreen 13. In another embodiment, the navigation module 50 reverts to a display of the selected panel 19a in navigation mode if the user stops the continuous swipe 50 before covering half of the display area 12a size (25% of screen width/height). However, if the user stops the continuous swipe 50 after covering half of the display area 12a (25% of screen width/height) but before covering full display area (100% of screen width/height), the navigation module 50 automatically identifies the navigation end location 54 to identify the direction vector V. In addition, the user can use the first 10% of continuous swipe 50 to determine if the predominant direction is horizontal or vertical, as discussed above with the direction vector V calculation.

In order to make the display sequence more pronounced, the navigation module 50 allows the users to control the display sequence during the intermediate path 53. This includes an intermediate zoom factor. The zoom curve during the display sequence is: zoom factor of starting scene→intermediate zoom factor→zoom factor of ending scene.

In shown embodiment, if one of the starting or ending zoom factors is 1.0 (no zoom), the intermediate zoom factor is halfway between starting and ending scene zoom factors (linear zoom adjustment—to avoid “over zoom out”). Otherwise, the zoom factor is calculated as 50% of the starting or scene. For instance, if the scene zoom factor of a selected panel is now 1.5 the intermediate zoom factor will be 1.25 as the scene progressed to the subsequent panel 19c.

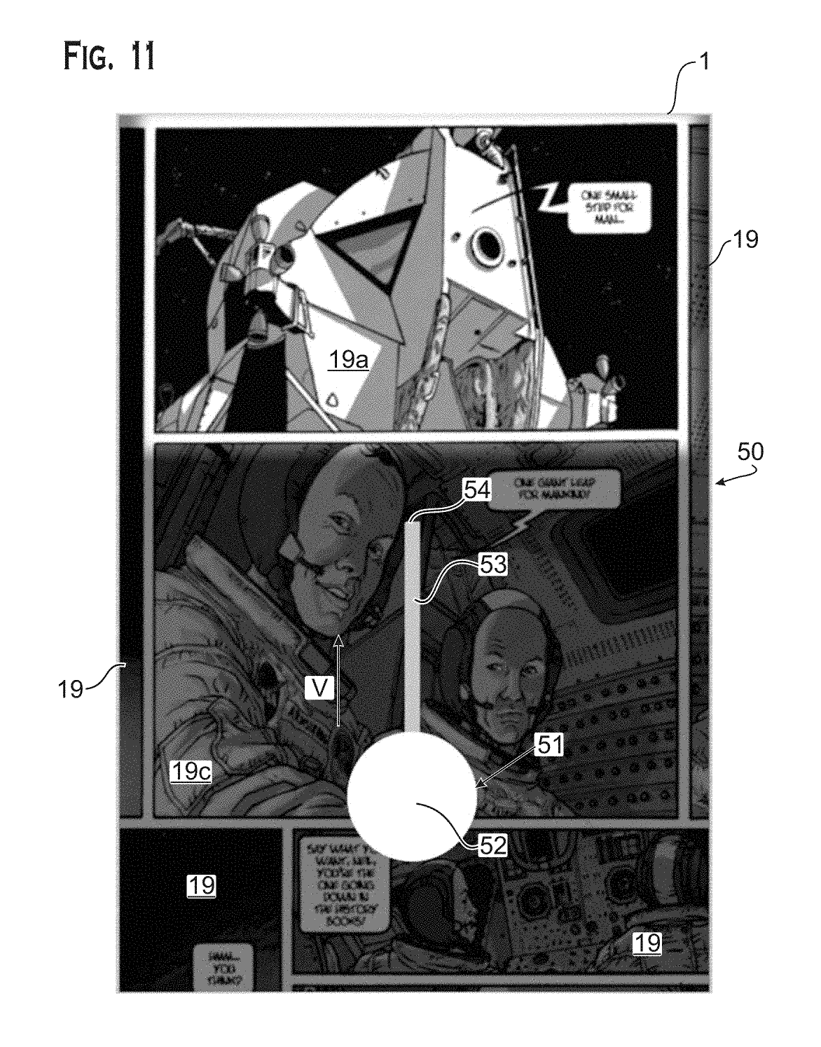

As shown in FIGS. 11 through 15, the user provides a navigation initiation location 52 that is consistent with a position of the subsequent panel 19c with respect to the selected panel 19. The user then slides across the general user interface 12 to a navigation end location 54 that is consistent with a position and direction of the selected panel 19a. In the shown embodiment, this is lateral motion and the navigation module 50 identifies this is in the form of the direction vector V, or vertical swipe in the embodiment shown. The navigation module 50 then determines the subsequent panel 19c and performs a display sequence as described above. At any time, the sequence can be controlled and moved back and forth by moving along the continuous swipe 51 before the finger is lifted from the touchscreen 13.

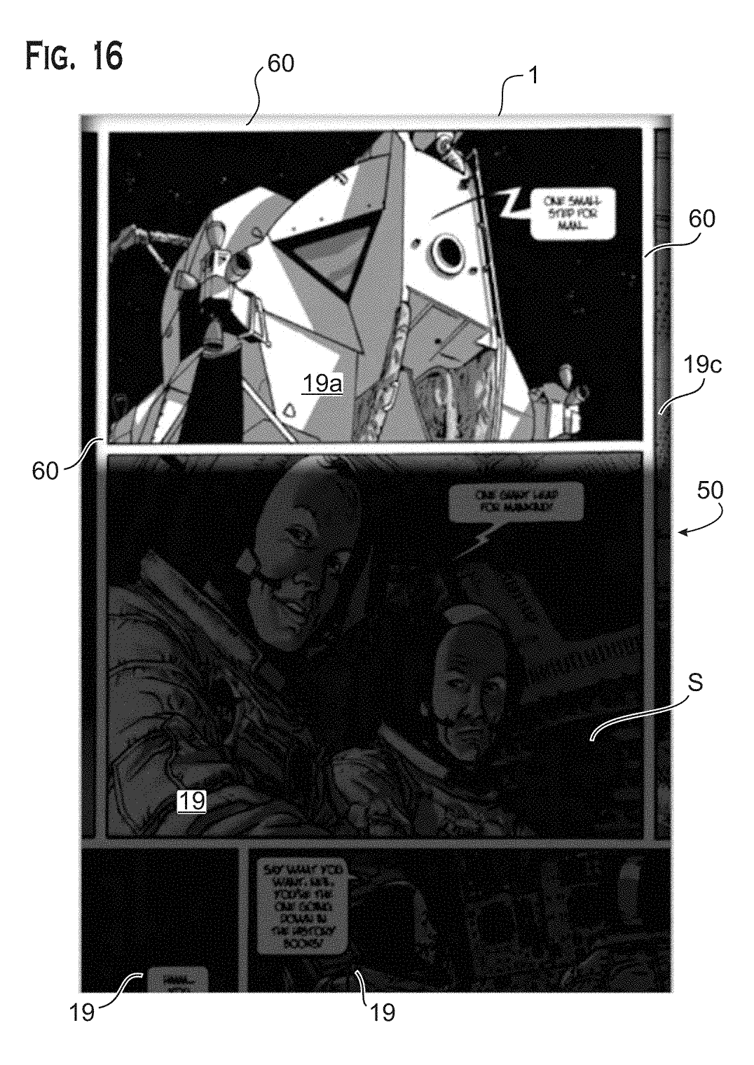

FIGS. 16 through 21 display another exemplary display sequence, wherein the user performs a continuous swipe 51 from right to left. The navigation module 50 determines the navigation initiation location 52, the navigation end location 54, and the intermediate path 53 in order to detriment the direction vector and display the appropriate display sequence.

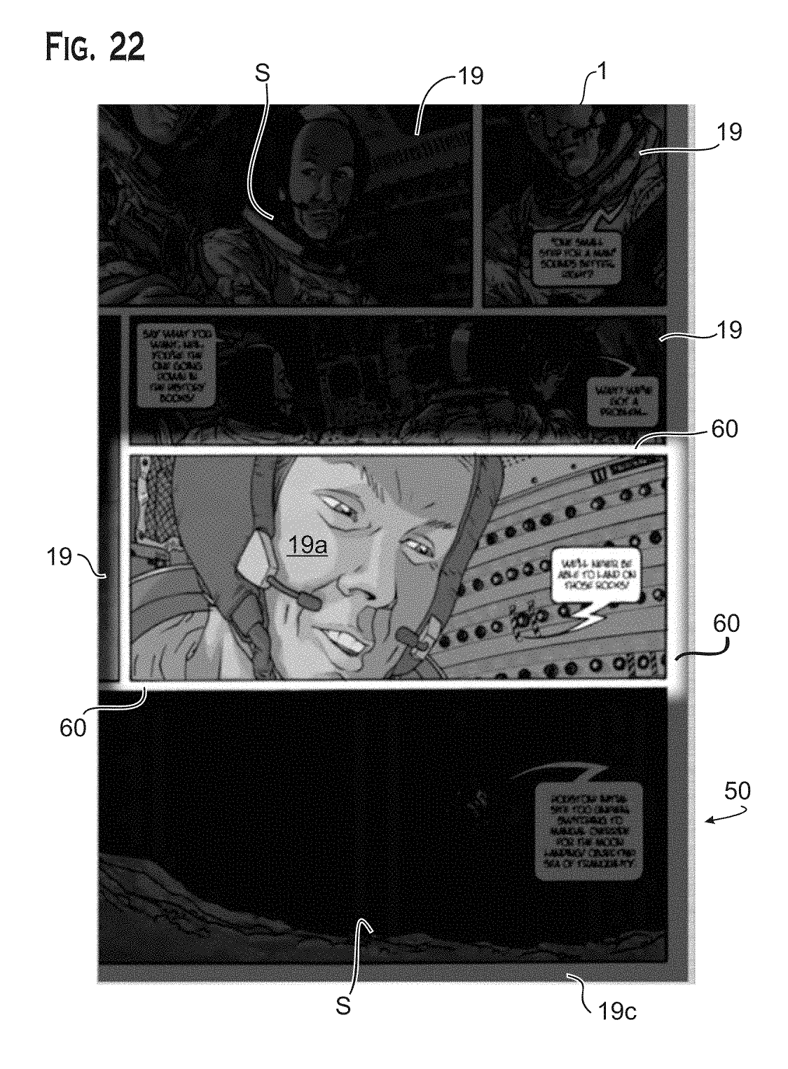

Likewise, FIGS. 22 through 28 display another exemplary display sequence, wherein the user performs a continuous swipe 51 from the bottom to the top of the display area 12a (i.e. in a continuous motion, as show in a sequence of FIGS. 22 through 28). The navigation module 50 again determines the navigation initiation location 52, the navigation end location 54, and the intermediate path 53 in order to detriment the direction vector and display the appropriate display sequence.

The display system 1 according to the invention makes use of the multimedia capabilities of computers and mobile devices, and leverages the communicative capability of a publication, such as a graphic novel/comic book format to provide a variety of contextual elements (e.g. locale, character, storyline), while the computational power of the device allows the user to navigate there through simple command.

The foregoing illustrates some of the possibilities for practicing the invention. Many other embodiments are possible within the scope and spirit of the invention. Therefore, more or less of the aforementioned components can be used to conform to that particular purpose. It is, therefore, intended that the foregoing description be regarded as illustrative rather than limiting, and that the scope of the invention is given by the appended claims together with their full range of equivalents.

What is claimed is:

1. A method of navigating panels of displayed content, comprising:
a plurality of image files 20 stored on a database 4 and having graphical data 24;
a computing device 10 having:
a memory device 15 used to retain digital data including the plurality of image files 20;
a central processing unit 16 for processing digital data stored in the memory device 15 by performing computations and sending instructions; and
a general user interface 12 with a display area 12a to receive and display a sequential juxtaposed plurality of panels 19 of displayed graphical data 24 in the display area 12a; and
a navigation module 50 stored in the database 4 and run by the central processing unit 16 to permit a user to switch between a display mode of the panels 19 and a navigation mode of the plurality of panels 19 as the user pans across the sequential juxtaposed panels 19 to choose and zoom in on a selected panel 19a.

2. The method of claim 1, wherein the display mode of panels 19 includes 100% of displayable content for each page of sequential juxtaposed panels 19 displayed in the display area 12a.

3. The method of claim 2, wherein the navigation module 50 zooms in and displays a zoomed image of the selected panel 19a when the user chooses the selected panel 19a.

4. The method of claim 3, wherein the user chooses the selected panel 19a by pointing and selecting a specific coordinate of a coordinate system of the general user interface 12 corresponds to one of the plurality of panels 19.

5. The method of claim 4, wherein the navigation module 50 zooms into the selected panel 19a and places a soft edge effect 60 about the selected panel 19a after the user chooses the selected panel 19a.

6. The method of claim 5, wherein the selected panel 19a may occupy about 85 to about 90% of the available of the display area 12a.

7. The method of claim 5, wherein the navigation module 50 concurrently provides shading S on top of the plurality of panels 19 surrounding the selected panel 19a.

8. The method of claim 7, wherein the user continues navigating the plurality of panels 19 by again selecting the general user interface 12 and providing a navigation initiation location 52.

9. The method of claim 8, wherein the user selects a subsequent panel 19c by performing a swipe gesture with respect to the position of the selected panel 19a and the plurality of panels 19 surrounding the selected panel 19a.

10. The method of claim 9, wherein the swipe gesture is performed in one continuous linear motion and the navigation initiation location 52 is identified and stored by the navigation module 50.

11. The method of claim 10, wherein the navigation module 50 evaluates a path of a continuous swipe 51 by determining a distance L between the navigation initiation location 52 and a navigation end location 54 of the path of the continuous swipe 51.

12. The method of claim 11, wherein the navigation end location 54 is determined once the swipe gesture has stopped.

13. The method of claim 12, wherein the navigation module 50 starts calculating a direction vector V of the path of the continuous swipe 51 through the selected coordinates of the navigation initiation location 52 and an intermediate path 53 that are coordinates between the navigation initiation location 52 and present position of the path of the continuous swipe 51.

14. The method of claim 13, wherein the navigation initiation location 52 is consistent with a position of the subsequent panel 19c with respect to the selected panel 19.

15. The method of claim 14, wherein user then slides across the general user interface 12 to a navigation end location 54 that is consistent with a position and direction of the selected panel 60.

16. The method of claim 15, wherein the swipe gesture is lateral motion that the navigation module 50 identifies is in the direction vector V.

17. The method of claim 16, wherein the navigation module 50 determines the subsequent panel 19c and performs a display sequence such that the subsequent panel 19c transitions to another selected panel 60.

18. The method of claim 17, wherein the display sequence can be controlled and moved back and forth by moving along the path of the continuous swipe 51.

19. The method of claim 17, wherein the display sequence includes zooming out and in of the plurality of panels 19 during the intermediate path 53.

20. The method of claim 1, wherein the plurality of image files 20 are downloaded over network 9.

21. The method of claim 1, wherein the plurality of image files 20 can be pre-loaded to the computing device 10.

22. The method of claim 1, wherein the computing device 10 is a tablet computer with a touchscreen display 11.

23. The method of claim 22, wherein the touchscreen display 11 uses finger or stylus gestures to navigate the general user interface 12 and choose the selected panel 19a through a swipe gesture.
